(19) United States
(12) Patent Application Publication
(10) Pub. No.: US 2021/0262979 A1
(43) Pub. Date: Aug. 26, 2021

(54) LIQUID HANDLING DEVICES AND METHODS IN CAPILLARY ELECTROPHORESIS

(71) Applicant: GMJ Technologies, Inc., Everett, WA (US)

(72) Inventor: Oluwatosin O. Dada, Everett, WA (US)

(73) Assignee: GMJ Technologies, Inc., Everett, WA (US)

(21) Appl. No.: 17/251,500

(22) PCT Filed: Jun. 12, 2019
(86) PCT No.: PCT/US19/36784

§ 371 Date: Dec. 11, 2020

Related U.S. Application Data
(60) Provisional application No. 62/683,907, filed on Jun. 12, 2018.

(51) Int. Cl. G01N 27/447; B01L 3/00

(52) U.S. Cl. CPC G01N 27/44743; B01L 3/502; G01N 27/44791; B01L 2400/06; B01L 2200/16; B01L 2200/026; B01L 2200/06

(57) ABSTRACT

An electrophoresis system for analysis of different analyte species and associated fluidic devices for holding sub-microliter volume is disclosed. A system comprises includes nanovials at several stations configured to permit introduction of reagents and samples into the capillary by means of applying pressure to nanovials and/or application of voltage to create a potential difference across the capillary. The capillary may be coupled to a detector and may be moved to different nanovials through an actuator that couples the capillary through a capillary mount that includes an integrated pressure line. The capillary inlet or outlet may be maintained at ground or maintained at a voltage. The use of an automated fluidic nanovial for buffer and sample manipulation in capillary based separations enables inline process analytics and offers an improvement on the ease-of-use and robustness of analytical instruments.

### CROSS-REFERENCE TO RELATED APPLICATIONS

This application is a national stage application, filed under 35 U.S.C. § 371, of International Patent Application No. PCT/US2019/36784, filed on Jun. 12, 2019, which claims the benefit of U.S. provisional patent application Ser. No. 62/683,907, filed on Jun. 12, 2018, each of which is incorporated herein by reference in its entirety.

### BACKGROUND

Capillary electrophoresis (CE) has been used for the analysis of inorganic, organic, and biological compounds. This electrophoretic technique generally includes the steps of 1) introducing reagents to condition the inner surface of the capillary, 2) filling the capillary with the background electrolyte, 3) injecting a plug or filling the capillary with a sample, and 4) applying an electric field across the capillary containing the sample solution. The applied field causes the different components of the unknown sample mixture to migrate inside the capillary at different speeds based on their charge characteristics. The separated components of the unknown sample are monitored downstream, in-capillary or off-capillary, with various detection schemes such as UV absorbance, laser-induced fluorescence, mass spectrometry, conductivity, photothermal, etc.

In conventional capillary electrophoresis systems (U.S. Pat. Nos., 6,001,230, 6,258,238, 9,140,666, and US Patent Publication 20180292350A1) and the capillary is mounted to a fixed support with the voltage electrode configured next to the capillary inlet. Consequently, the voltage electrode is in contact with a liquid that the capillary inlet is dipped into. To introduce reagents or the sample into the capillary, the reagent vials or the sample vials are transported to meet with the capillary inlet and outlet. Commonly, the reagents or the sample are introduced into the capillary from a large liquid volume, typically 1.5 μL, pipetted manually into the vials. This often requires preparing samples in excess (100X-10,000X) of actual volume needed since the maximum volume required by CE is typically 1 μL or less. This approach results in sample waste. Also, multiple buffer vials are required in order to have enough reagent volume for a large sample set operation. Vial-to-vial variation in the buffer component increases the injection-to-injection variation. More so, the existing vial configurations do not permit automated inline filling, and therefore prevent automated sample transfer from an external liquid line. All of these limitations present challenges for the use of CE for routine applications. Furthermore, lack of a fully automated liquid handling system that permits analysis with submicroliters volume is a major drawback for sample-limited applications as used in clinical analysis and in-line process analytics.

To address these problems, the present disclosure introduces new devices and approaches for liquid handling in capillary electrophoresis and other capillary-based separation techniques.

### BRIEF SUMMARY

An electrophoresis system may utilize fluidic devices with several stations configured to permit introduction of reagents and samples into the capillary by means of applying pressure to liquid vials and application of voltage to create a potential difference across the capillary. The capillary may be coupled to a detector and may be moved to different liquid vials through an actuator that couples the capillary through a capillary mount that includes an integrated pressure line. The capillary inlet or outlet may be maintained at ground or maintained at a voltage.

In some configurations, the electrophoresis system may include liquid vials for holding a liquid and placing the liquid into a capillary.

In some configurations, the electrophoresis system may include a capillary configured to contain a sample liquid, the capillary having an inlet configured to receive the sample liquid and an outlet configured to expel sample solution.

In some configurations of the electrophoresis system, the capillary may be moved to different liquid vials through an actuator that couples the capillary through a capillary mount.

In some configurations of the electrophoresis system, the capillary is coupled to a sensitive detector, wherein the detector is configured for in-capillary or off-capillary detection.

In some configurations of the electrophoresis system, the position of the liquid vials may be changed through a transport system to couple with a stationary capillary.

In some configurations, the electrophoresis system may include an electrode connected to a voltage source, wherein the voltage source is configured internal or external to the electrophoresis system.

In some configurations, the electrophoresis system may include electromechanical valves for liquid control, wherein the valve is configured within or outside of the electrophoresis system.

In some configurations, the electrophoresis system is configured to permit analysis of unknown sample mixtures of inorganic compounds, organic compounds, biomolecules, nanostructures, and cells.

The electrophoresis system may include a system of placing a liquid into a capillary by means of pressure or electromigration.

A method of placing a liquid sample into a capillary may involve delivering the liquid sample into a nanovial. “Liquid sample” refers to any liquid that may be added to the vials in this disclosure. In some embodiments, the liquid sample may be a sample to be analyzed or may be a liquid reagent that is used in performing the analysis. The method may then form a sealed nanovial by closing the nanovial with an injection lid. The injection lid may seal the top portion of the nanovial and may provide a capillary opening and a pressure line opening. The method may then pressurize the nanovial using a pressure line, thereby placing the liquid sample into the capillary.

In the method, the nanovial includes a top portion, a tapered portion, and a lower portion.

The top portion may include an inner top portion diameter wider than a capillary diameter. The tapered portion may include a narrower inner tapered portion diameter than the inner top portion diameter and connected to the top portion. The lower portion may include an inner lower portion diameter narrower than the inner top portion diameter and the inner tapered portion diameter. The tapered portion may taper the interior diameter of the nanovial from the top portion to the lower portion. The inner lower portion diameter may be wide enough to receive the capillary and a lower portion height may be tall enough to allow the liquid sample to rise to a height that may be above the bottom of the capillary and to the height that provides sufficient volume to deliver a desired sample size without the level of the liquid sample falling below the end of the capillary.

In some configurations of the method, the amount of the liquid sample placed into the nanovial is 0.5 μL or more. In some embodiments, the amount of the liquid sample placed into the nanovial is 2 μL or less.

In some configurations of the method, the sealed nanovial is pressurized by way of the pressure line at a pressure ranging between 0.1 psi and 100 psi.

In some configurations of the method, the inner top portion diameter ranges between 1.0 mm to 10 mm.

In some configurations of the method, the inner lower portion diameter ranges between 20 μm and 1000 μm.

A nanovial may include a top portion, a tapered portion, and a lower portion. The top portion may include an inner top portion diameter wider than a capillary diameter. The tapered portion may include a narrower inner tapered portion diameter than the inner top portion diameter and connected to the top portion. The lower portion may include an inner lower portion diameter narrower than the inner top portion diameter and the inner tapered portion diameter. The tapered portion may taper the interior diameter of the nanovial from the top portion to the lower portion.

In some configurations, the nanovial may include a lower opening in the bottom of the lower portion.

In some configurations of the nanovial, the inner top portion diameter ranges between 1.0 mm to 10 mm.

In some configurations of the nanovial, the inner lower portion diameter ranges between 20 μm and 1000 μm.

In some configurations, the lower portion comprises a lower opening allowing fluid communication with a valve system, wherein the valve system is configured to block the lower opening or allow flow through the lower opening. Additionally, the lower portion may include external threading for coupling with the valve system.

A method of transferring a liquid sample into a capillary involve providing a nanovial for forming a sealed nanovial by closing the nanovial with an injection lid. The injection lid may seal the top portion of the nanovial and provide access for a capillary opening and pressure line. The method may then transfer the liquid sample into the nanovial through the lower opening and blocking the lower opening using the valve system. The method may then pressurize the sealed nanovial using a pressure line, thereby placing the liquid sample into the capillary by way of the capillary opening.

In the method, the nanovial may include a top portion, a tapered portion, and a lower portion with a lower opening. The top portion includes an inner top portion diameter wider than a capillary diameter. The tapered portion includes a narrower inner tapered portion diameter than the inner top portion diameter and connected to the top portion. The lower opening may be at the bottom of the lower portion allowing fluid communication with a valve system. The valve system may be configured to block the lower opening or allow flow through the lower opening. The lower portion includes an inner lower portion diameter narrower than the inner top portion diameter and the inner tapered portion diameter. The tapered portion tapers the interior diameter of the of the nanovial from the top portion to the lower portion. The inner lower portion diameter may be wide enough to receive the capillary and a lower portion height is tall enough to allow the liquid sample to rise to a height that is above the bottom of the capillary and to the height that provides sufficient volume to deliver a desired sample size without the level of the liquid sample falling below the end of the capillary.

In some configurations, the sealed nanovial is pressurized at a pressure ranging between 0.1 psi and 100 psi.

In some configurations, the inner top portion diameter ranges between 1.0 mm to 10 mm.

In some configurations, the inner lower portion diameter ranges between 20 μm and 1000 μm.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an electrophoresis system 100 in accordance with one embodiment.

FIG. 2 illustrates a nanovial fluidic system 200 in accordance with one embodiment.

FIG. 3 illustrates a sample loading process 300 in accordance with one embodiment.

FIG. 4 illustrates a sample handling process 400 in accordance with one embodiment.

FIG. 5 illustrates a nanovial 500 in accordance with one embodiment.

FIG. 6 illustrates a nanovial 600 in accordance with one embodiment.

FIG. 7 illustrates an injection process 700 in accordance with one embodiment.

FIG. 8 illustrates an electrophoresis vial 800 in accordance with one embodiment.

FIG. 9 illustrates an electrophoresis vial 800 in accordance with one embodiment.

FIG. 10 illustrates a capillary injection process 1000 in accordance with one embodiment.

FIG. 11 illustrates a nanovial 1100 in accordance with one embodiment.

FIG. 12 illustrates a nanovial 1100 in accordance with one embodiment.

FIG. 13 illustrates a capillary injection process 1300 in accordance with one embodiment.

### DETAILED DESCRIPTION

This present invention introduces new approaches for capillary electrophoresis utilizing an automated nanovial fluidic mechanism for liquid handling and automated capillary positioning. A nanovial fluidic mechanism has immediate applications in capillary electrophoresis separation. In existing capillary electrophoresis systems, buffer and sample handling requires extensive operator intervention. The use of an automated fluidic device for buffer and sample manipulation offers a significant improvement for the ease-of-use, minute sample handling, and system robustness.

The nanovial fluidic device may be utilized to address short comings in the prior art by utilizing an automated fluidic nanovial system for buffer and sample manipulation.

Capillary separation systems that allow injection from sub-microliter volume are uncommon. An existing sample vial design that allows low microliter volume is based on manual pipetting and does not permit automatic inline transfer from an external line. Short comings from these approaches are due to manual pipetting and the large number of liquid vials that increases the instrument complexity, analysis variation, and failure rates. In addition, the use of large volume vials often leads to sample waste since the maximum volume typically injected in capillary electrophoresis is often less than 1 μL.

This nanovial fluidic device offers improvements and several advantages over the existing technologies. The nanovial fluidic device provides a mechanism that allows injection of liquid into a narrow bore capillary from 0.5 μL or more. In an embodiment, the amount of the liquid sample placed into the capillary is 2 μL or less.

The nanovial fluidic device creates a mechanism for inline introduction of buffers, samples, and other liquid reagents from external lines.

The nanovial fluidic device provides a means for coupling capillary electrophoresis with other liquid separation such as Chromatography.

Assembly of the nanovial may be accomplished utilizing a polymer-based material. The nanovial may be assembled through a process that involves mounting a tapered micro channel to a screw-like fitting. Alternatively, a tapered micro tubing might be inserted into the screw-like fitting and connected to a module of a valve port. The valve may have at least three interconnected ports. The tapered end of the nanovial may be towards the threaded end of the fitting. The sample line, the buffer line, and the waste line may then be connected to the remaining valve ports. The nanovial-valve module may then be assembled into an injection block or a supporting manifold. The sample and buffer lines may then be driven with syringe or automatic pumps delivering the sample to the nanovial. The valve and the pump operations may be controlled with a computer program.

The assembly of a capillary-pressure line module may include the creation of a manifold to hold the capillary and the pressure line in place over the nanovial. The manifold may be constructed from a polymer. The manifold may have a channel, about the outer diameter of the capillary, to insert the capillary through. The manifold may then be connected to a low pressure (0.1-100 psi) line. The sample may then be injected into the capillary after the manifold is secured to the nanovial-valve assembly and pressure is applied to from the pressure line.

In some configurations, the nanovial valve may utilize cross PEEK fittings, the cross PEEK fittings may be replaced with solenoid valves. Electric actuated valves may also be used in place of the solenoid valves. The syringe pumps may be replaced with automatic pumps. Different types of pumps may be used to drive the sample and the reagent lines.

The nanovial fluidic device described may be utilized to automate buffer transfer and sample injection in a seamless closed system like capillary electrophoresis.

It may be used to perform efficient analysis with ultralow sample volume (5 μL or less) volume. The system may be used to couple capillary electrophoresis as a second dimension separation to other liquid separations such as size exclusion chromatography (SEC), ion exchange chromatography (IEX), RPLC, capillary isoelectric focusing, capillary sieving electrophoresis and many more. It may also be used to integrate a capillary as a delivery module for any kind of liquid separation. With a looping microcolumn, the fluidic nanovial may permit sample pre-treatment prior to analysis in several applications. As an example, samples separated by chromatography may be fractionated and digested on a looping column. The digested sample may then be eluted into the nanovial for subsequent separation. Another application is for sample pre-concentration or pre-cleaning to remove non-volatile buffer excipients prior to analysis with less operator intervention.

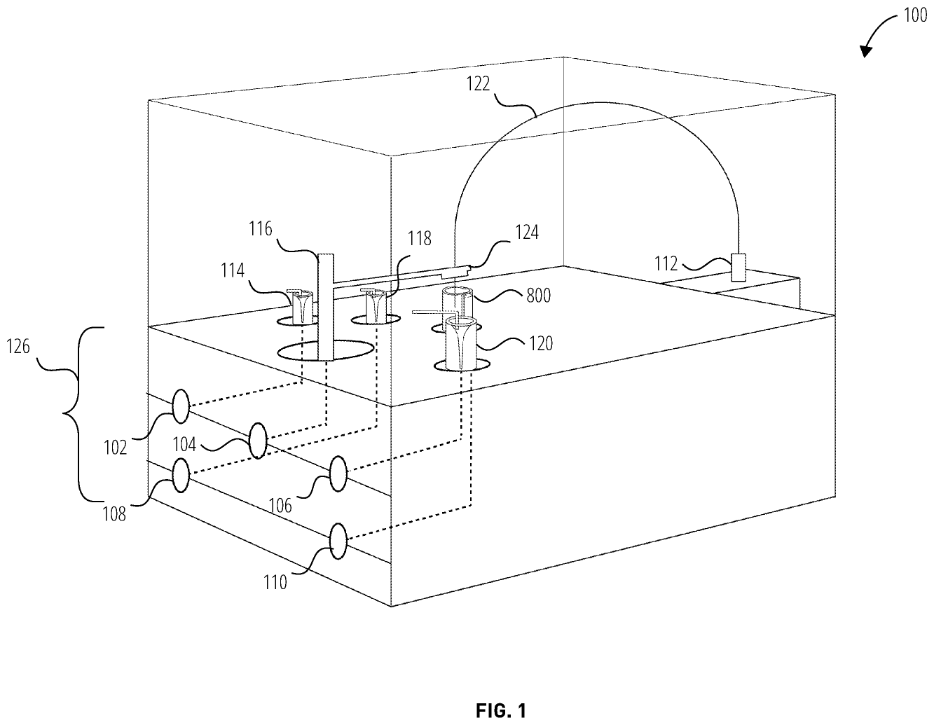

FIG. 1 illustrates an electrophoresis system 100 that utilizes nanovial fluidic devices. The electrophoresis system 100 may include several stations with the open bottom configured nanovials for loading reagents and samples into the capillary 122. The capillary 122 may be coupled to a detector 112 and may be moved to the different nanovials through a rotary actuator 116 that couples the capillary 122 through a capillary mount 124 that includes an integrated pressure line. Below each station, the nanovials may be coupled to a valve system 126 that delivers reagents and samples through the lower opening of the vial, and then closes to allow the pressure line to inject the fluid into the capillary 122. The valve system 126 may be configured internal or external to the electrophoresis system 100 and may be used in plurality for each of the nanovials. The rotary actuator 116 may receive pressure 104 through a similar manner as the valve system 126 from a pressure control system configured internal or external to the electrophoresis system 100.

In the electrophoresis system 100, the rotary actuator 116 may position the capillary mount 124 and the capillary 122 over the nanovial 114. The reagent 102 may be fed to the nanovial 114 through the valve system 126. The reagent 102 may then be introduced into the capillary 122 by way of pressure 104 applied from the pressure line. The rotary actuator 116 may then move the capillary mount 124 and the capillary 122 to the next station with the nanovial 118. The nanovial 118 may be then receive a reagent 108 from the valve system 126 in a similar manner as the nanovial 114. The reagent 108 may then be introduced into the capillary 122 by way of pressure 104 applied from the pressure line. The rotary actuator 116 may then move the capillary mount 124 and the capillary 122 to the next station with nanovial 120. In this position the nanovial 120 may receive the sample 106 through the valve system 126. The sample 106 may then be injected into the capillary 122 by way of pressure 104 applied from the pressure line. With the sample 106 and reagents (reagent 102 and reagent 108) loaded into the capillary 122, the rotary actuator 116 may move the capillary mount 124 and the capillary 122 to an electrophoresis vial 800 containing an integrated electrode placed in a buffer solution. The electrophoresis system 100 may use a plurality of the electrophoresis vial 800 configured on an actuator that allows selection of different vial positions. The integrated electrode of the electrophoresis vial 800 may be coupled to an electrode 110 integrated within the electrophoresis system 100. The electrode 110 is connected to a voltage source configured internally or externally to the electrophoresis system 100. When the capillary electrophoresis process starts, the electrode 110 may apply a voltage to the integrated electrode of the electrophoresis vial 800 causing charged molecules to move towards the potentiated buffer solution. During this movement, target molecules may be detected at the opposite end of the capillary 122 at a detector 112.

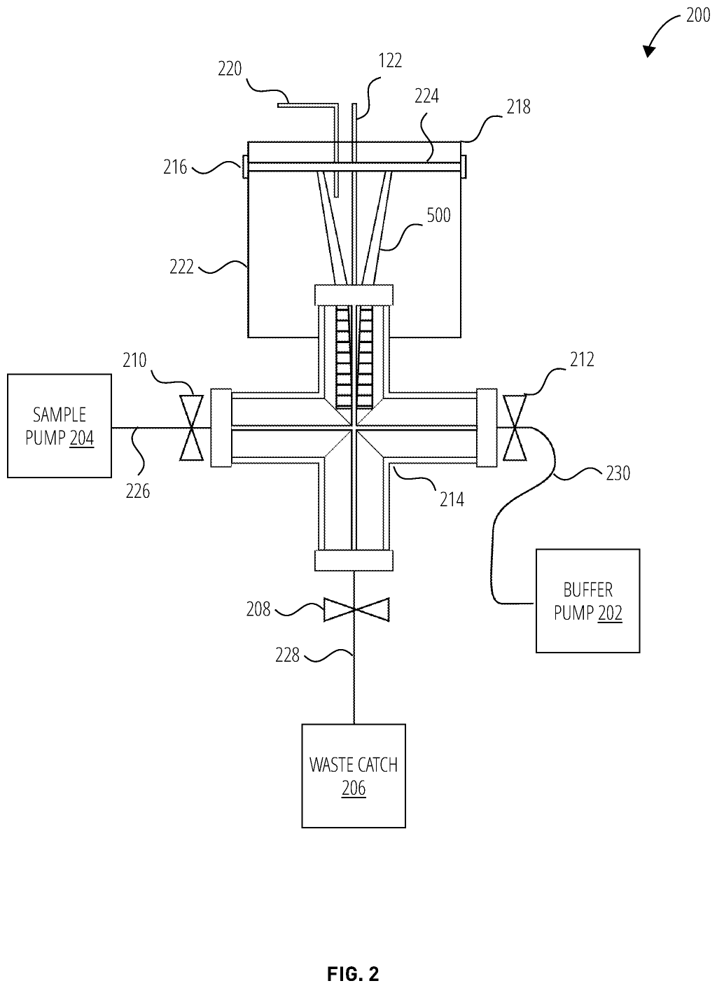

Referencing FIG. 2, the nanovial fluidic system 200 comprises a buffer pump 202, a sample pump 204, a waste catch 206, a waste line valve 208, a sample line valve 210, a buffer line valve 212, a cross PEEK fitting 214, clamps 216, an injection lid 218, a pressure line 220, a capillary 122, an injection manifold 222, a rubber seal 224, a nanovial 500, a sample line 226, a waste line 228, and a buffer line 230.

The nanovial 500 is threaded into one of the lines in a cross PEEK fitting 214. The nanovial 500 is hand tight to prevent any leak. The nanovial 500 and the cross PEEK fitting 214 assembly is then fused into an injection manifold 222 through an air-tight connection from the bottom of the injection manifold 222. The injection lid 218 is positioned over the nanovial 500 holding the capillary 122. The pressure line 220 is then clamped to the injection manifold 222 with clamps 216. A rubber seal 224 is positioned between injection manifold 222 and the injection lid 218 and provides a tight seal between the base of the injection manifold 222 and the injection lid 218. The sample pump 204, the buffer pump 202, and the waste catch 206 are connected to the cross PEEK fitting 214. The buffer line valve 212, sample line valve 210, and the waste line valve 208 are then used to set each line in an opened or closed state.

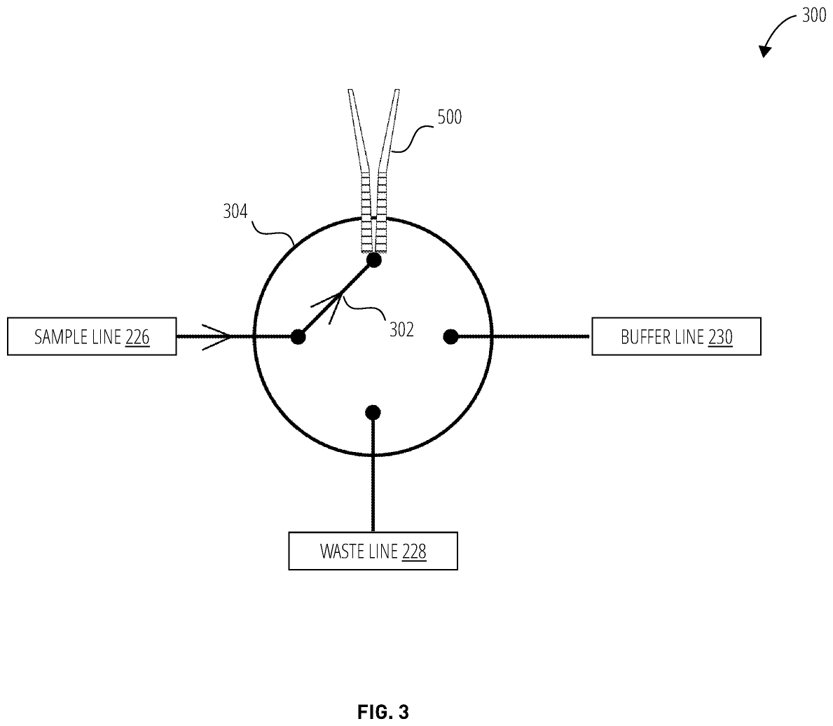

FIG. 3 illustrates a sample loading process 300 where the cross PEEK fitting 214 is replaced with a switching valve 304. During the sample loading process 300, the waste line valve 208 and the buffer line valve 212 are closed, shutting off access to the waste line 228 and the buffer line 230, respectively. The sample line valve 210 remains open allowing the liquid sample to flow through the sample line 226 into the nanovial 500 through the bottom inlet of the nanovial 500 as shown by the fluid direction 302. Each line of the switching valve may also be configured differently for different liquid. The buffer line valve 212, sample line valve 210, and the waste line valve 208 serve as a logic gate that can be controlled with subroutines depending on the phase of the electrophoresis process.

For example, for loading the sample into the nanovial 500, the sample line valve 210 would be in the open or ON position, while the buffer line valve 212 and the waste line valve 208 would be in the closed or OFF position. For filling the buffer solution, the buffer line valve 212 would be in the open or ON position, while the sample line valve 210 and the waste catch 206 would be in the closed or OFF position. For the purging of the nanovial 500, the waste line valve 208 would be in the open or ON position, while the sample line valve 210 and the buffer line valve 212 would be in the closed or OFF position.

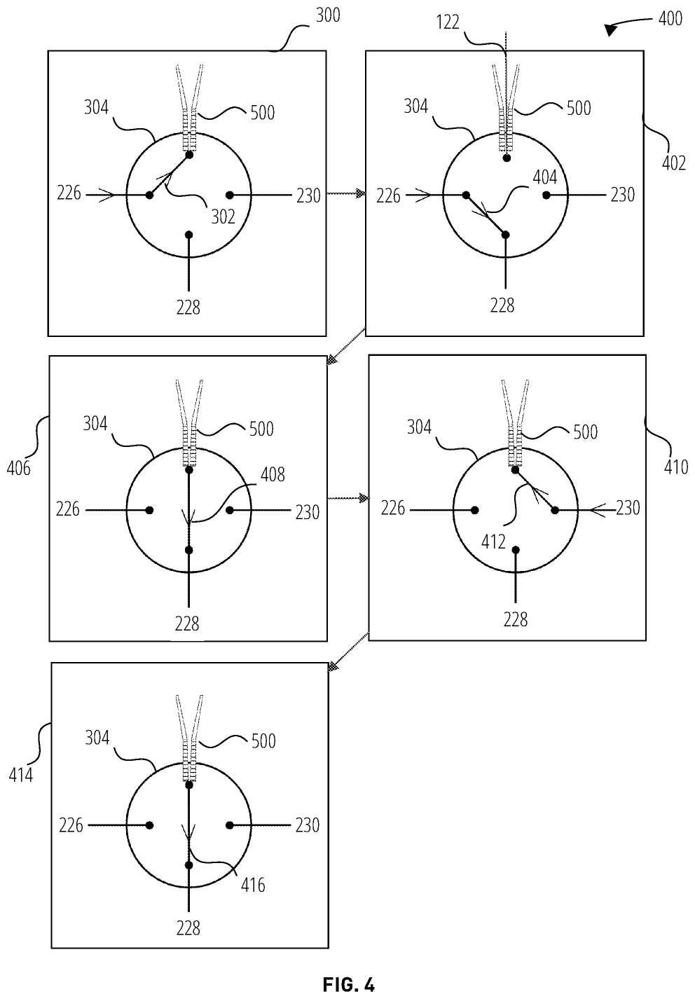

FIG. 4 illustrates a sample handling process 400. The sample handling process 400 begins with the sample loading process 300. Once the sample loading process 300 completes, the sample handling process 400 moves to sample injection process 402, where the sample within the nanovial 500 is loaded into the capillary 122. The opening to the nanovial 500 is closed as well as the opening to the buffer line 230. The fluid direction 404 within the switching valve 304 is configured to allow fluid communication from the sample line 226 to the waste line 228. From the sample injection process 402, the sample handling process 400 moves to a first vial empty process 406, where the nanovial 500 is emptied into the waste line 228. In the first vial empty process 406, the sample line 226 and the buffer line 230 are closed, and the fluid direction 408 is from the nanovial 500 to the waste line 228. Following the first vial empty process 406, the sample handling process 400 moves to a buffer rinse process 410, where buffer solution flushes the nanovial 500. In the buffer rinse process 410, the sample line 226 and the waste line 228 are closed and the nanovial 500 and the buffer line 230 are in fluid communication allowing the fluid direction 412 towards the nanovial 500. Following the buffer rinse process 410, the sample handling process 400 moves to the second vial empty process 414. In the second vial empty process 414, the buffer rinse from the nanovial 500 is ejected towards the waste line 228. The sample line 226 and the buffer line 230 are closed and the nanovial 500 and the waste line 228 are in fluid communication allowing the fluid direction 416 of buffer rinse to flow towards the waste line 228.

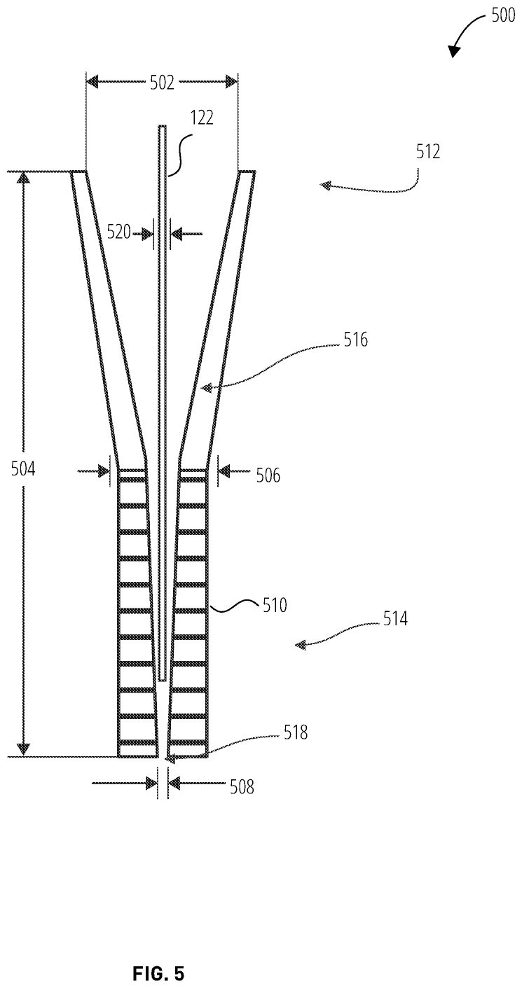

FIG. 5 illustrates a cross sectional view of the nanovial 500. The nanovial 500 comprises a top portion 512 and a lower portion 514, with at least one tapered portion 516 in the interior of the nanovial 500. The lower portion 514 may include external threading 510 to help secure the nanovial 500 in place. When the injection lid and pressure line are attached and the lower opening 518 is closed, the nanovial 500 may be pressurized to a pressure ranging between 0.1 psi and 100 psi. The inner top portion diameter 502 may range between 1.0 mm to 10 mm. The inner tapered portion diameter 506 between where the top portion 512 and the lower portion 514 are found may range be 600 μm. The height 504 of the nanovial 500 may be between 1-5 centimeters. The inner lower portion diameter 508 may range between 20 μm and 1000 μm. The lower opening 518 may be between 20 to 500 μm in diameter. The nanovial 500 may receive a capillary 122 with a capillary diameter 520 ranging between 20-400 μm in diameter.

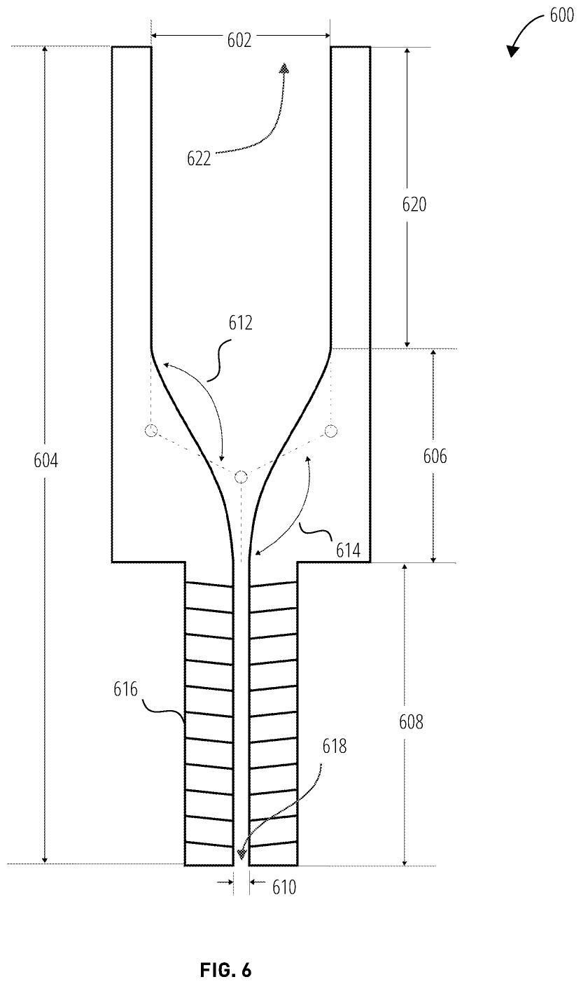

FIG. 6 illustrates a cross sectional view of a nanovial 600. The nanovial 600 is an open bottom configuration of the nanovial that may be utilized with a fluid control valve. The nanovial 600 includes a top portion 620, a tapered portion 606, and a lower portion 608. The top portion 620 includes a top opening 622. The lower portion 608 includes a lower opening 618 and an external threading 616. The dimensions of the nanovial 600 may be proportionally related to the height 604 of the nanovial 600. For instance, the inner top portion diameter 602 may measure 25% of the height 604. The top portion 620 and the lower portion 608 may measure 37.5% of the height 604. The tapered portion 606 may measure 25% of the height 604. The inner lower portion diameter 610 may measure 1.0-4.0% of the height 604. The tapered portion 606 includes at least a curvature 612 and a curvature 614 that form the taper between the top portion 620 and the lower portion 608. The curvature 612 and the curvature 614 may have curvature angles measuring a 125°±5°.

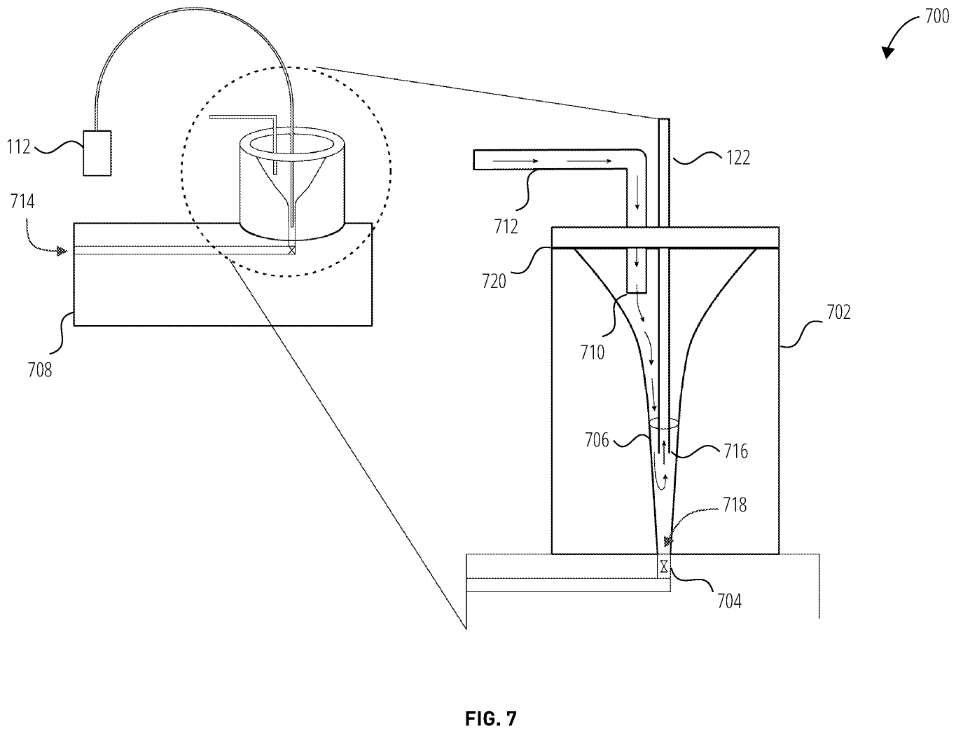

FIG. 7 illustrates an injection process 700 utilizing a nanovial 702 with an open bottom and a valve system 708. The valve system 708 includes flow inline 714 and a valve 704 that are disposed towards the lower opening 718 of the nanovial 702. The liquid sample 706 may be loaded into the nanovial 702 from the flow inline 714 by way of the valve 704 in an open configuration allowing the liquid sample 706 to travel into the nanovial 702. When the liquid sample 706 is loaded into the nanovial 702, the valve 704 may close, the valve 704 preventing backflow aided by the interior tapering of the nanovial 702. With the pressure line 712 and capillary 122 mounted within the nanovial 702 forming a sealed nanovial through the injection lid 720, pressure exiting the pressure line 712 from the pressure line opening 710 may force the liquid sample 706 within the nanovial 702 up into the capillary 122 by way of the capillary opening 716.

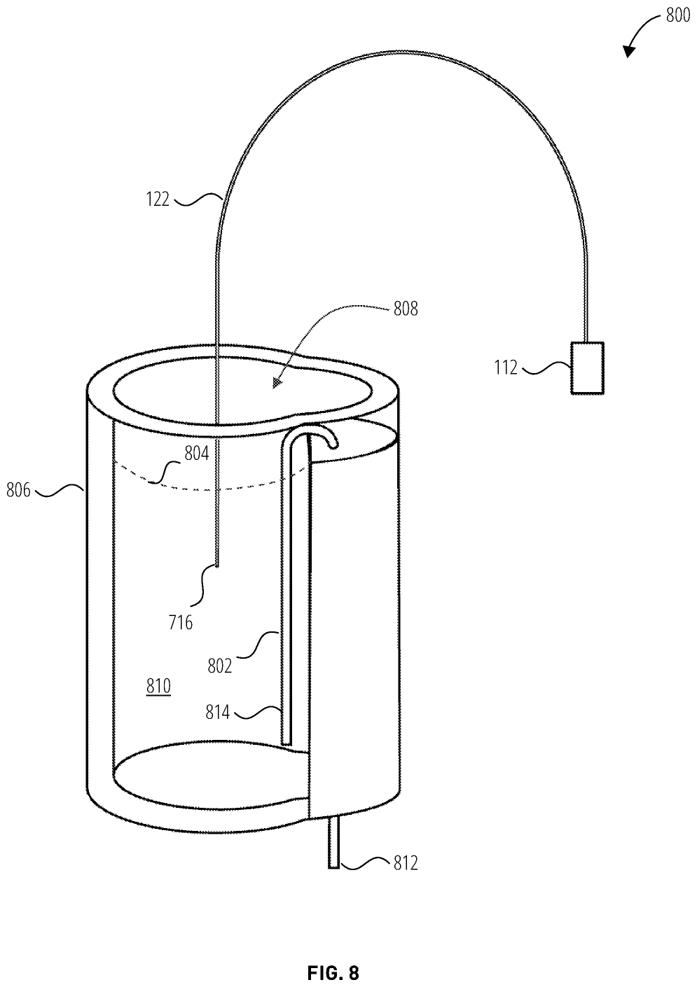

FIG. 8 illustrates an electrophoresis vial 800 that may be utilized in the electrophoresis system 100. The electrophoresis vial 800 comprises a well 810 that holds the buffer solution 804. The integrated electrode 802 traverses through the body 806 of the electrophoresis vial 800 and curves into the well 810 positioning a first end 814 within the buffer solution 804. A second end 812 of the integrated electrode 802 is terminated below the body 806 of the electrophoresis vial 800 and allows for coupling with the electrode 110 of the electrophoresis system 100. When the capillary 122 is loaded with a sample solution, the capillary opening 716 of the capillary 122 enters the electrophoresis vial 800 through the top opening 808 and is submerged into the buffer solution 804 within the well 810. The integrated electrode 802 then receives voltage from the electrode 110 by way of the second end 812, delivering such voltage at the first end 814 to cause analyte mobility to the detector 112. In another configuration of the electrophoresis system 100, the outlet end of the capillary 122 may also be inserted into another unit of the electrophoresis vial 800.

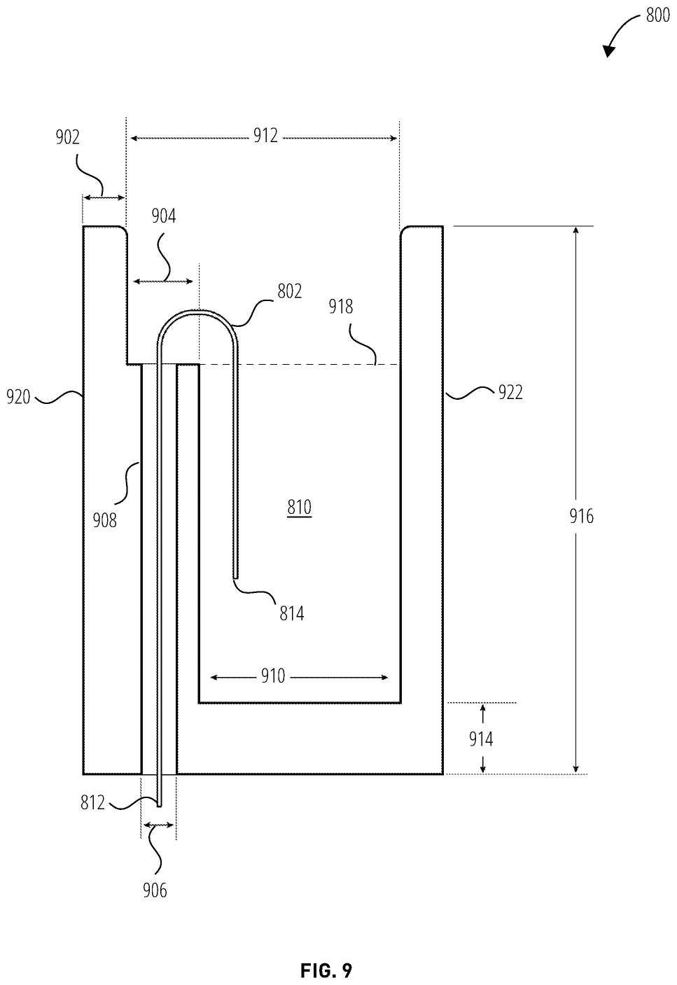

FIG. 9 illustrates a sectional view of the electrophoresis vial 800. The electrophoresis vial 800 comprises an electrode conduit 908 for the integrated electrode 802 positioned adjacent to the well 810. The well 810 and the electrode conduit 908 are positioned between a lateral wall 920 and a lateral wall 922 that form the body 806 of the electrophoresis vial 800. Compared to the lateral wall 922 and the lateral wall 920, the well 810 and the electrode conduit 908 are shorter in height such that they allow the integrated electrode 802 to curve from the electrode conduit 908 into the well 810 limiting unwanted interactions with a capillary mount or injection lid. When buffer solution is added to the well 810, the buffer solution height 918 may be limited to the height of the outer wall of the electrode conduit 908 to prevent spillage into the electrode conduit 908.

In a configuration, the electrophoresis vial 800 may have a height 916 ranging between 0.5-1.5 inches.

The electrophoresis vial 800 may have a width 902 for the lateral wall 920 and lateral wall 922 that is approximately 1/16th of an inch, with a distance 912 between the lateral wall 920 and the lateral wall 922 ranging between 0.2-0.5 inches. The well 810 may have a width 910 ranging between 0.05-0.3 inches from the lateral wall 922 to the outer wall of the electrode conduit 908. The electrode conduit 908 may have an outer width 904 ranging between 0.05-0.2 inches. The electrode conduit 908 may have an interior width 906 that is approximately 1/16th of an inch. The thickness of material below the well 810 may have a height 914 that is approximately 0.12 inches.

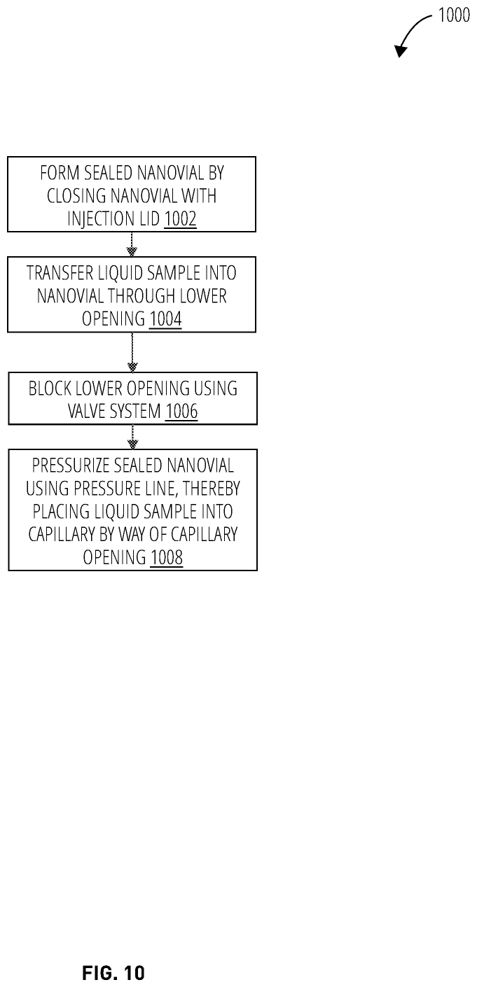

FIG. 10 illustrates a capillary injection process 1000 for placing a liquid sample into a capillary. The capillary injection process 1000 is for a nanovial with an open bottom configuration adapted for use with a valve system. The nanovial includes a top portion, a tapered portion, and a lower portion with a lower opening. The top portion includes an inner top portion diameter wider than a capillary diameter. The tapered portion includes a narrower inner tapered portion diameter than the inner top portion diameter and connected to the top portion. The lower opening may be at the bottom of the lower portion allowing fluid communication with a valve system. The valve system may be configured to block the lower opening or allow flow through the lower opening. The lower portion includes an inner lower portion diameter narrower than the inner top portion diameter and the inner tapered portion diameter. The tapered portion tapers the interior diameter of the nanovial from the top portion to the lower portion. The inner lower portion diameter may be wide enough to receive the capillary and a lower portion height is tall enough to allow the liquid sample to rise to a height that is above the bottom of the capillary and to the height that provides sufficient volume to deliver a desired sample size without the level of the liquid sample falling below the end of the capillary.

The capillary injection process 1000 may involve forming a sealed nanovial by closing the nanovial with an injection lid (block 1002) or other sealing mechanisms. The injection lid may seal the top portion of the nanovial and provide a capillary opening and pressure line. In another configuration the injection lid may also provide a voltage electrode line. In block 1004, the capillary injection process 1000 transfers the liquid sample into the nanovial through the lower opening. In block 1006, the capillary injection process 1000 blocks the lower opening using the valve system. In block 1008, the capillary injection process 1000, pressurizes the sealed nanovial using a pressure line, thereby placing the liquid sample into the capillary by way of the capillary opening.

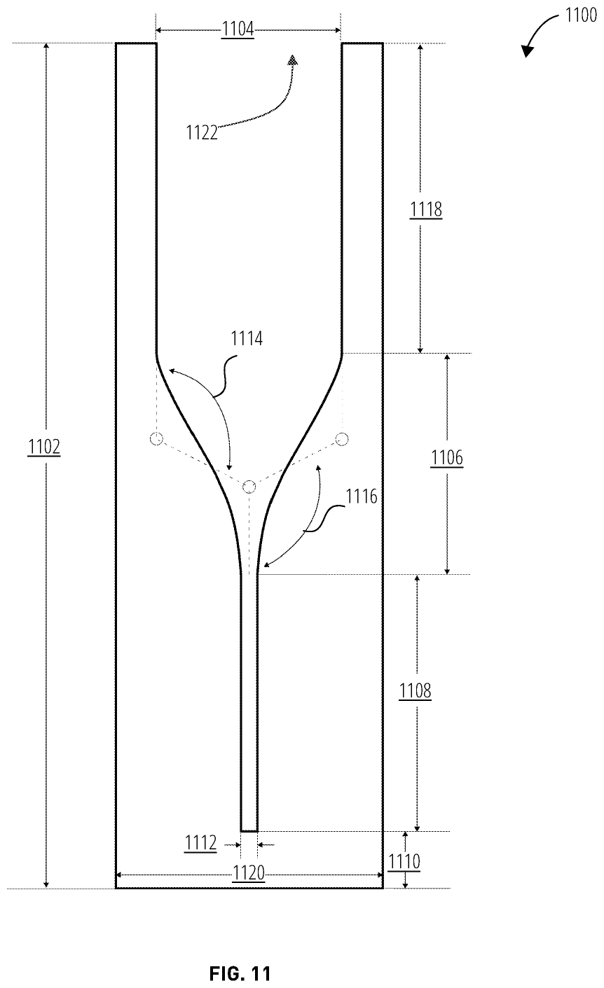

FIG. 11 illustrates a cross sectional view of a nanovial 1100. The nanovial 1100 is configured with a closed bottom and may not be used with a fluid control valve. The nanovial 1100 includes a top portion 1118, a tapered portion 1106, a lower portion 1108, and a bottom section 1110. The top portion 1118 includes a top opening 1122 through which the pressure line, capillary, and liquid sample enter the nanovial 1100. The top opening may also provide a voltage electrode line in another configuration. The tapered portion 1106 includes curvature 1114 and curvature 1116 that forms the taper towards the lower portion 1108. The interior of the lower portion 1108 is coincident with the bottom section 1110 closing the lower portion 1108. The dimensions of the nanovial 1100 may be proportionally related to the height 1102 of the nanovial 1100. For instance, the inner top portion diameter 1104 may measure 25% of the height 1102. The top portion 1118 may measure 37.5% of the height 1102. The tapered portion 1106 and the lower portion 1108 may both measure 25% of the height 1102. The width 1120 of the nanovial 1100 may measure approximately 32% ±1% of the height 1102. The inner lower portion diameter 1112 may be between 1.0 and 4.0% of the height 1102. The bottom section 1110 may measure 12.5% of the height 1102. The tapered portion 1106 includes at least a curvature 1114 and a curvature 1116 that form the taper between the top portion 1118 and the lower portion 1108. The curvature 1114 and the curvature 1116 may have a curvature angles measuring a 125°±5°.

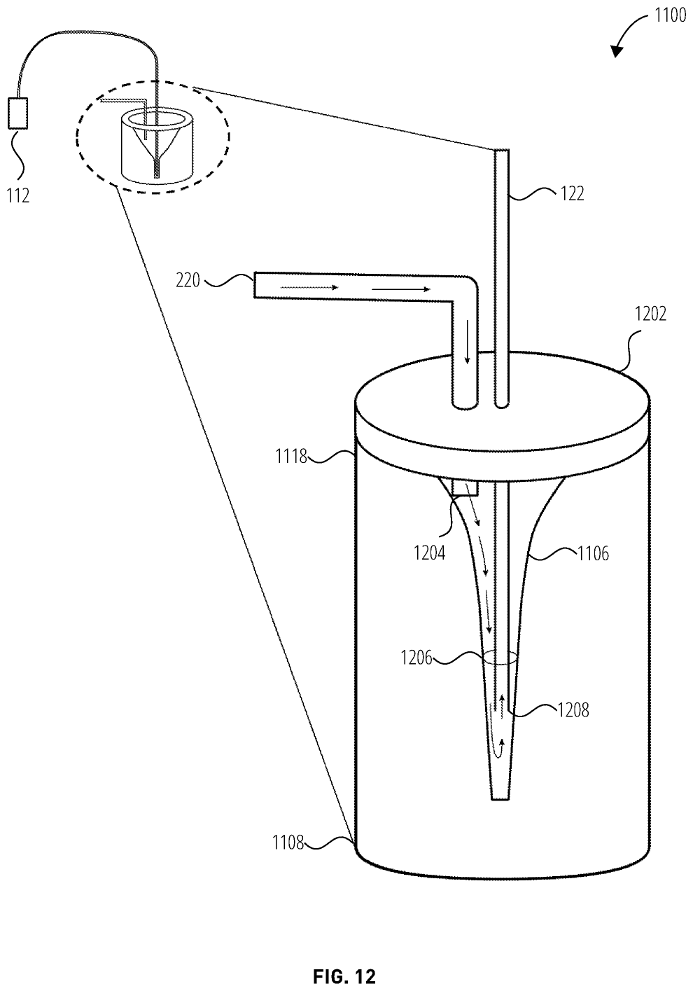

FIG. 12 illustrates a nanovial 1100 with a closed bottom configuration. The nanovial 1100 includes a top portion 1118, a tapered portion 1106, a lower portion 1108 that is closed at the bottom. The liquid sample 1206 may be present within the nanovial 1100 before the injection lid 1202 is attached, and the pressure line 220 and the capillary 122 are inserted through an opening in the injection lid. When pressure is applied through the pressure line 220, the pressure from the pressure line opening 1204 within the nanovial 1100 may cause the liquid sample 1206 to enter the capillary 122 through the capillary opening 1208. In another configuration where voltage is applied to the nanovial through a voltage electrode inserted through an opening in the injection lid, a potential difference across the capillary may cause the liquid sample 1206 to enter the capillary 122 by a means of electromigration towards the detector 112.

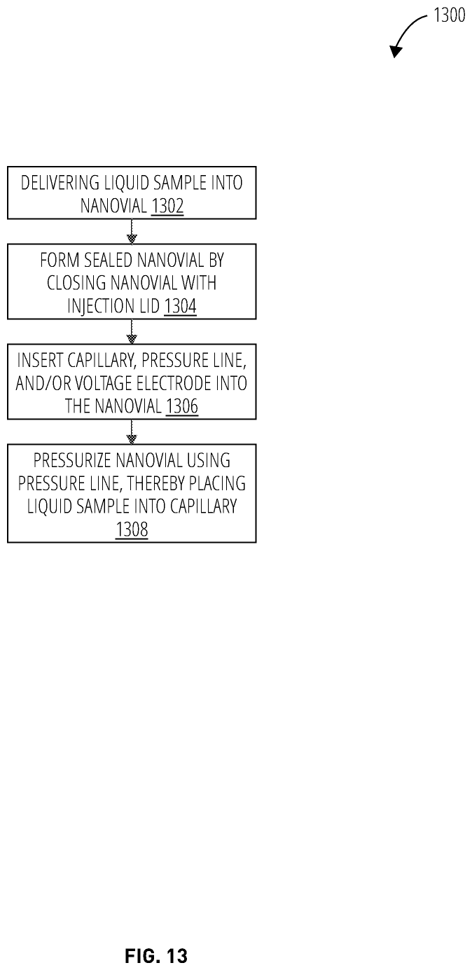

FIG. 13 illustrates a capillary injection process 1300 for placing a liquid sample into a capillary. The capillary injection process 1300 is for a nanovial that includes a top portion, a tapered portion, and a lower portion without a lower opening. The top portion includes an inner top portion diameter wider than a capillary diameter. The tapered portion may be a narrower inner tapered portion diameter than the inner top portion diameter and connected to the top portion. The lower portion may have an inner lower portion diameter narrower than the inner top portion diameter and the inner tapered portion diameter. The tapered portion tapers the interior diameter of the nanovial from the top portion to the lower portion. Additionally, the inner lower portion diameter is wide enough to receive the capillary and a lower portion height is tall enough to allow the liquid sample to rise to a height that is above the bottom of the capillary and to the height that provides sufficient volume to deliver a desired sample size without the level of the liquid sample falling below the end of the capillary.

The capillary injection process 1300 may involve delivering the liquid sample into a nanovial (block 1302). In block 1304, the capillary injection process 1300 then forms a sealed nanovial by closing the nanovial with an injection lid, wherein the injection lid seals the top portion of the nanovial and provides a capillary opening and a pressure line opening. In block 1306, the capillary injection process 1300 inserts the capillary, the pressure line and/or a voltage electrode into the nanovial in a way that maintains the sealed nanovial. In block 1308,

The entire fluidic system functions as a whole to perform low volume liquid introduction into a narrow capillary. The system works in multiple ways for sample injection, buffer filling, and electrophoretic separation. During sample injection, first the buffer line and the waste line are closed. The injection lid holding the capillary and the pressure line are also disengaged. The sample line is open for a set time to deliver a set amount of the sample between 0.5 μL-10 μL into the nanovial. After the nanovial is filled with the sample, the system is closed with the injection lid engaged. The sample is introduced into the capillary by applying pressure for a given time period. For buffer filling, the same procedure is followed with the sample and the waste lines closed while the buffer line is open for a set time. To drain the nanovial, the waste line is open while the sample and the buffer lines are closed. To clean the system, sample and the buffer lines are connected to the cleansing reagents. The system is filled with the cleaning reagent and purged to the waste. Draining can be achieved with gravity flow or by applying negative pressure to the waste line (vacuum). An electric field is applied to the capillary filled with a sample solution to cause the sample constituents to move through the capillary by means of electromigration. The electromigrating species are then monitored by a sensitive detection method.

The methods and apparatuses in this disclosure are described in the preceding on the basis of several preferred embodiments. Different aspects of different variants are considered to be described in combination with each other such that all combinations that upon reading by a skilled person in the field on the basis of this document may be regarded as being read within the concept of the invention. The preferred embodiments do not limit the extent of protection of this document.

Having thus described embodiments of the present invention of the present application in detail and by reference to illustrative embodiments thereof, it will be apparent that modifications and variations are possible without departing from the scope of the present invention.

What is claimed is:

1. A method of handling a liquid sample in a capillary electrophoresis system, the method comprising:
delivering the liquid sample into a nanovial, wherein the nanovial includes:
a top portion with an inner top portion diameter wider than a capillary diameter;
a tapered portion with a narrower inner tapered portion diameter than the inner top portion diameter and connected to the top portion; and
a lower portion with an inner lower portion diameter narrower than the inner top portion diameter and the inner tapered portion diameter, wherein the tapered portion tapers an interior diameter of the nanovial from the top portion to the lower portion, wherein the inner lower portion diameter is wide enough to receive the capillary and a lower portion height is tall enough to allow the liquid sample to rise to a height that is above the bottom of the capillary and to the height that provides sufficient volume to deliver a desired sample size without the level of the liquid sample falling below the end of the capillary;
forming a sealed nanovial by closing the nanovial with an injection lid, wherein the injection lid seals the top portion of the nanovial and provides a capillary opening and a pressure line opening; and
pressurizing the nanovial using a pressure line, thereby placing the liquid sample into the capillary.

2. The method of claim 1, wherein the amount of the liquid sample placed into the capillary is 2 μL or less.

3. The method of claim 1, wherein the sealed nanovial is pressurized by way of the pressure line at a pressure ranging between 0.1 psi and 100 psi.

4. The method of claim 1, wherein the inner top portion diameter ranges between 1.0 mm to 10 mm.

5. The method of claim 1, wherein the inner lower portion diameter ranges between 20 μm and 1000 μm.

6. The method of claim 1, wherein the inner lower portion diameter is between 1.0-4.0% of an overall height of the nanovial measured from the top of the top portion to the bottom of the lower portion.

7. A nanovial comprising:
a top portion with an inner top portion diameter wider than a capillary diameter;
a tapered portion with a narrower inner tapered portion diameter than the inner top portion diameter and connected to the top portion; and
a lower portion with an inner lower portion diameter narrower than the inner top portion diameter and the inner tapered portion diameter, wherein the tapered portion tapers an interior diameter of the nanovial from the top portion to the lower portion.

8. The nanovial of claim 7, further comprising a lower opening in the bottom of the lower portion.

9. The nanovial of claim 7, wherein the inner top portion diameter ranges between 1.0 mm to 10 mm.

10. The nanovial of claim 7, wherein the inner lower portion diameter ranges between 20 μm and 1000 μm.

11. The nanovial of claim 7, wherein the inner lower portion diameter is between 1.0-4.0% of an overall height of the nanovial measured from the top of the top portion to the bottom of the lower portion.

12. The nanovial of claim 7, wherein the lower portion comprises a lower opening allowing fluid communication with a valve system, wherein the valve system is configured to block the lower opening or allow flow through the lower opening.

13. The nanovial of claim 12, wherein the lower portion comprises external threading for coupling with the valve system.

14. A method of transferring a liquid sample into a capillary, the method comprising:
providing a nanovial, the nanovial including:
a top portion with an inner top portion diameter wider than a capillary diameter;
a tapered portion with a narrower inner tapered portion diameter than the inner top portion diameter and connected to the top portion; and
a lower portion including:
a lower opening at the bottom of the lower portion allowing fluid communication with a valve system, wherein the valve system is configured to block the lower opening or allow flow through the lower opening; and
the lower portion with an inner lower portion diameter narrower than the inner top portion diameter and the inner tapered portion diameter, wherein the tapered portion tapers an interior diameter of the of the nanovial from the top portion to the lower portion, wherein the inner lower portion diameter is wide enough to receive the capillary and a lower portion height is tall enough to allow the liquid sample to rise to a height that is above the bottom of the capillary and to the height that provides sufficient volume to deliver a desired sample size without the level of the liquid sample falling below the end of the capillary;
forming a sealed nanovial by closing the nanovial with an injection lid, wherein the injection lid seals the top portion of the nanovial and provides a capillary opening and a pressure line opening;
transferring the liquid sample into the nanovial through the lower opening and blocking the lower opening using the valve system; and
pressurizing the sealed nanovial using a pressure line, thereby placing the liquid sample into the capillary by way of the capillary opening.

15. The method of claim 14, wherein the sealed nanovial is pressurized at a pressure ranging between 0.1 psi and 100 psi.

16. The method of claim 14, wherein the inner top portion diameter ranges between 1.0 mm to 10 mm.

17. The method of claim 14, wherein the inner lower portion diameter ranges between 20 μm and 1000 μm.

18. The method of claim 14, wherein the inner lower portion diameter is between 1.0-4.0% of an overall height of the nanovial measured from the top of the top portion to the bottom of the lower portion.

19. A system for analyzing samples of inorganic, organic, and biological species, wherein the system includes:
at least one nanovial for holding a liquid sample and placing the liquid sample into a capillary, the nanovial comprising:
a top portion with an inner top portion diameter wider than a capillary diameter;
a tapered portion with a narrower inner tapered portion diameter than the inner top portion diameter and connected to the top portion; and
a lower portion with an inner lower portion diameter narrower than the inner top portion diameter and the inner tapered portion diameter, wherein the tapered portion tapers an interior diameter of the nanovial from the top portion to the lower portion; the capillary:
configured to contain the liquid sample;
having an inlet configured to receive the liquid sample and an outlet configured to expel the liquid sample;
configured to be moved to a different nanovial through an actuator that couples the capillary through a capillary mount;
coupled to a detector, wherein the detector is configured for in-capillary or off-capillary detection;
an actuator configured to change the position of the nanovials allowing the nanovials to couple with a stationary capillary;
an electrode connected to a voltage source, wherein the voltage source is configured internal or external to the system;
an electromechanical valve system for liquid control, wherein the electromechanical valve system is configured within or outside of the system;
a pressure control system for pushing the liquid sample into the capillary; and
an analysis unit configured to permit analysis of the liquid sample, wherein the analysis unit includes separation of the liquid sample driven by means of pressure or electromigration.

20. The system for analyzing samples of claim 19, further comprising an electrophoresis vial including the electrode, wherein the electrophoresis vial is configured to hold an electrolyte and receive the capillary with the liquid sample into the electrolyte.
